(19) United States
(12) Patent Application Publication
(10) Pub. No.: US 2013/0039762 A1
(43) Pub. Date: Feb. 14, 2013

(54) ADJUSTMENT SYSTEM FOR THE PITCH ANGLE OF A WIND TURBINE

(71) Applicants: Juhani EKOLA, Ekola (FI); Patrik HOLM, Vaasa (FI)

(72) Inventors: Juhani EKOLA, Ekola (FI); Patrik HOLM, Vaasa (FI)

(73) Assignee: MERVENTO OY, Vaasa (FI)

(21) Appl. No.: 13/558,680

(22) Filed: Jul. 26, 2012

(30) Foreign Application Priority Data
Aug. 12, 2011 (FI) 20115793

(51) Int. Cl. F03D 1/06; F03D 7/02

(52) U.S. Cl. 416/9

(57) ABSTRACT

Adjustment system for the pitch angle of a wind turbine, which wind turbine includes an axis of rotation that is horizontal or at a small angle with respect to the horizontal plane, and a rotating hub to which the blades are connected in a manner allowing their slewing, in which system an adjustment arrangement is arranged inside the hub and/or shaft. The arrangement includes a drive device moving in the direction of the axis of rotation as well as an adjustment cylinder apparatus or corresponding for moving it. Rod-shaped control parts for each blade are connected in a hinged manner to the drive device. The control parts are connected to the butt part of each blade such that the pitch angle can be adjusted by shifting the drive device.

### FIELD OF TECHNOLOGY

The object of the present invention is an adjustment system for the pitch angle of a wind turbine.

More particularly, the object of the invention is an adjustment system for the pitch angle of a wind turbine of a high rated capacity, typically in the MW output range.

### BACKGROUND OF THE INVENTION AND PRIOR ART

In a wind power station wind power is utilized. In it the kinetic energy of wind is converted into electricity, e.g. via the rotating blades of wind turbines. Wind power is renewable energy, which originates from solar radiation.

Wind turbines are consequently used to an increasing extent for the production of electrical energy. One significant technical problem with wind turbines is the great stochastic variation in wind speed and also the wind speed gradient caused by the friction of the earth.

Adjustment of the power taken by the rotor is achieved in modern power stations by an adjustment of the pitch angle. That wind speed with which a wind turbine achieves its rated power is called its rated wind speed; the speed of rotation of the turbine and of the generator can vary below the rated wind speed as the speed of the wind changes. Above the rated wind speed the speed of rotation and the power is kept constant by adjusting the pitch angle.

Generally the stopping of large wind power stations occurs by slewing the blades to an angle of 90 degrees with respect to the plane of rotation. In this case there must be an individual adjustment of the pitch angle for each blade, i.e. so that each blade can be adjusted individually and independently of the others. This means that e.g. when one blade jams the other blades can be adjusted so that the turbine can be stopped.

In principle, the pitch angle is always kept constant up until the rated wind speed of the turbine. In this case the speed of rotation of the turbine changes when the wind speed changes such that the angle of incidence of the blade with respect to the air flow remains correct. Above that the pitch angle of the blades is adjusted so that the same speed and power as at the rated wind speed is obtained. When the wind speed increases, the angle of incidence of the blades is reduced, in which case they take a smaller part of the power that is in the wind.

More particularly, for this purpose wind turbines are provided with adjustment systems for the pitch angle, with which systems the angle of the blades is adjusted by slewing the blades of the rotor around their longitudinal axis, in which case operation of a wind power station at the optimum power is enabled in changing wind conditions while at the same time the startability of the wind turbine is improved and the operation of the wind turbine is prevented e.g. at overhigh wind speeds by slewing the blades into the idle state.

Nowadays the pitch angle is adjusted either electrically or hydraulically. In electrical adjustment geared motors are used, and the slewing bearings of a blade are provided with a gear rim. The geared motor comprises a pinion, which is connected to the gear rim. The number of speeds in a geared motor is relatively high, around 1000. The motors are generally direct-current motors and are provided with large cooling fans. The system must operate also without an external supply of electricity, so that batteries are disposed in the hub of the rotor. The lifetime of these types of rotating batteries is short. In addition to this, terminal boxes and other electrical devices for adjusting the pitch angle are needed in the hub, in which case the system is complex.

In hydraulic adjustment the blades are slewed hydraulically. Many prior-art systems contain a lot of components in the rotating hub, and this causes technical problems.

### SUMMARY OF THE INVENTION

The purpose of this invention is to achieve a system for the adjustment of the pitch angle of a wind turbine that is simpler and more operationally reliable than prior-art solutions. More particularly, one aim is to achieve a system in which the amount of hydraulic components in the rotating hub is minimized. In addition, with the invention it is desired to reduce mechanical stresses and to improve the efficiency ratio and productivity of a turbine.

The system according to the invention is based e.g. on a mechanical hydraulic solution in which adjustment of the pitch angle occurs by the aid of a drive device moving in the direction of the axis of rotation and inclining in relation to the other axes. Rod-shaped control parts are mounted on bearings (hinged) onto a drive device, which control parts are connected to the blades for slewing them and for adjusting the pitch angle.

In the system according to the invention the pitch angle can be adjusted continuously with an extremely simple and reliable arrangement.

The characteristic features of the system according to the invention are described in detail in independent claim 1, and of its preferred embodiments in the other claims.

By inclining the drive device, better efficiency is achieved according to the wind gradient (wind shear) up until the rated wind speed. Above the rated wind speed, an even loading in the whole area of the rim is achieved by the inclining.

When the wind speed increases to be too high, the system enables slewing of the blades into an idle state which functions as an aerodynamic brake.

### SHORT DESCRIPTION OF THE DRAWINGS

In the following, the invention will be described in more detail by the aid some embodiments with reference to the attached drawings, wherein

FIG. 1 presents a wind turbine,

FIG. 2 presents the shaft of a wind turbine and an adjustment system according to the invention as a partial cross-section,

FIG. 3 presents an oblique rear view of an adjustment system according to the invention as a perspective drawing, and

FIG. 4 presents an oblique front view of an adjustment system according to the invention as a perspective drawing.

### DETAILED DESCRIPTION OF EMBODIMENTS OF THE INVENTION

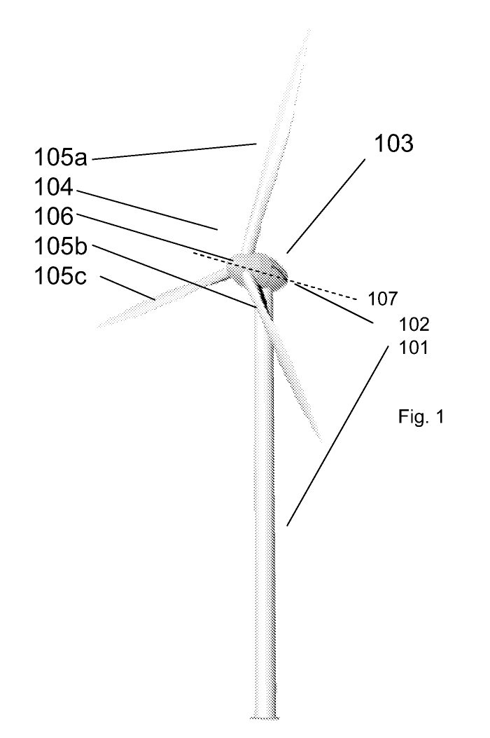

FIG. 1 presents the machinery 102 of a wind turbine of a MW power range, typically over 2.5 MW, disposed on top of a tower 101, which machinery comprises a nacelle 103, a rotor 104, which comprises three blades 105a-105c, and also a hub 106. The blades are attached to the hub by the aid of ring bearings. A plastic cover is on the outside of the hub. In the direct-drive wind turbine presented in FIG. 1, wherein the generator is connected directly to the hub of the rotor without gearing, the axis of rotation 107 of the rotor is horizontal or nearly horizontal. The shaft belonging to the nacelle is open on the inside. Inside it and inside the hub is disposed an adjustment system for the pitch angle according to the invention.

The adjustment system for the pitch angle according to the invention is based on a drive device of the so-called swash plate type moving in the direction of the axis of rotation of the rotor (in the axial direction) and inclining in relation to the other axes, which drive device continuously adjusts the pitch angle of the blades of the rotor by the aid of control rods.

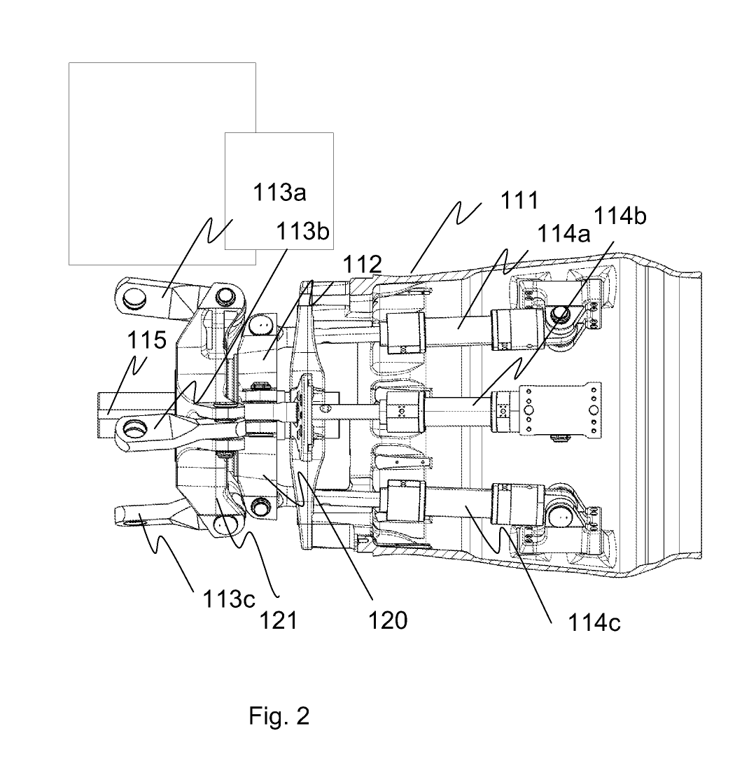

FIG. 2 presents a shaft and an adjustment system inside the hub. Leaving from the drive device 112 mounted on bearings inside the hollow shaft 111 are rods with fixing lugs 113a-113c slewing the blades. The longitudinal adjustment cylinders 114a-114c (3 units, at 120-degree intervals on the rim), which are fixed to the hollow shaft 111 in a hinged manner at one of their ends and to a non-rotating frame part 120 of the drive device at the other of their ends, shift the drive device along a longitudinal fixed slide tube 115. The drive device arranged on top of the fixed slide tube is a drive device of the swash plate type, which is formed from a non-rotating frame part 120 and from a rotating hinging part 121 mounted on it on bearings. The ball-type bearing enables inclination of the whole drive device when the cylinders are controlled to be of different lengths. Control rods 113a-113c slewing the blades are hinged to the rotating hinging part of the drive device.

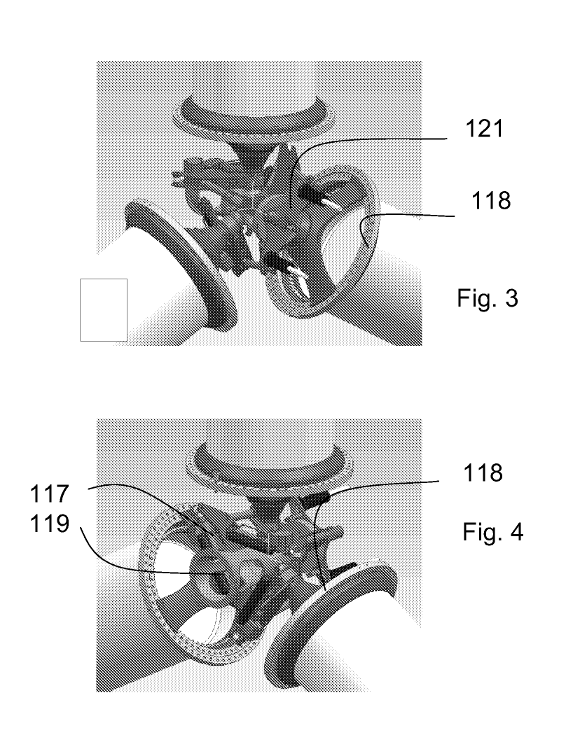

FIGS. 3 and 4 present stopping cylinders 117 (one for each blade), the ring bearings 118 (three units) of the blades, and the pressure accumulators 119 (one for each stopping cylinder).

The adjustment cylinders 114a-114c slew the ring bearings 118 via the swash plate. When the length of the adjustment cylinders is changed to differ from each other, the swash plate inclines and in this way the pitch angle can be driven with the rotational rim of the blades to be continuously changing.

The stopping cylinders 117 enable slewing of the blades to an angle of 90 degrees with respect to the plane of rotation and in this way the using of the blades as an aerodynamic brake. The pressure accumulators 119 enable an emergency stop if the normal power supply cannot be used in a fault situation.

Control rods 113a-113c for each blade are connected in a hinged manner to the drive device, which control rods are connected to the butt part of each blade such that the pitch angle can be adjusted by shifting the drive device with the adjustment cylinders. The drive device can be brought to slide along the fixed slide tube 115 and can be inclined owing to its ball-type bearing.

It is obvious to the person skilled in the art that the different embodiments of the invention are not limited solely to the example described above, but that they may be varied within the scope of the claims presented below.

In place of adjustment cylinders, e.g. linear electric motors can also be used.

1. Adjustment system for the pitch angle of a wind turbine, which wind turbine comprises an axis of rotation that is horizontal or at a small angle with respect to the horizontal plane, and a rotating hub to which the blades are connected in a manner allowing their slewing,
wherein the system comprises
an adjustment arrangement arranged inside the hub and/or shaft, which arrangement comprises a drive device moving in the direction of the axis of rotation as well as an adjustment cylinder apparatus or corresponding for moving it, and also
rod-shaped control parts for each blade that are connected in a hinged manner to the drive device, which control parts are connected to the butt part of each blade such that the pitch angle can be adjusted by shifting the drive device.

2. Adjustment system according to claim 1,
wherein the drive device can be brought to slide along a fixed slide tube.

3. Adjustment system according to claim 1,
wherein, an inclining drive device is arranged to slide on top of the fixed slide tube, which inclining drive device is formed from a non-rotating frame part and from a rotating hinging part mounted on it on bearings, to which rotating hinging part the rod-shaped control parts slewing the blades are hinged.

4. Adjustment system according to claim 1,
wherein the blades can be slewed to a stop position with separate stopping cylinders such that each blade can be separately slewed into the stop position.

5. Adjustment system according to claim 2, wherein, an inclining drive device is arranged to slide on top of the fixed slide tube, which inclining drive device is formed from a non-rotating frame part and from a rotating hinging part mounted on it on bearings, to which rotating hinging part the rod-shaped control parts slewing the blades are hinged.

6. Adjustment system according to claim 2, wherein the blades can be slewed to a stop position with separate stopping cylinders such that each blade can be separately slewed into the stop position.

7. Adjustment system according to claim 3, wherein the blades can be slewed to a stop position with separate stopping cylinders such that each blade can be separately slewed into the stop position.
